(19) United States
(12) Patent Application Publication
(10) Pub. No.: US 2026/0340680 A1
(43) Pub. Date: Oct. 29, 2026

(54) PRIVACY-PRESERVING BROWSER EXTENSION OR BROWSER FOR ON-DEVICE ADVERTISING WITH ENCRYPTED USER PROFILING

(71) Applicant: The People’s Internet Experiment, Inc., Marina Del Rey, CA (US)

(72) Inventors: Ryan Hudson, Tujunga, CA (US); Anthony Le, Los Angeles, CA (US); Spencer Allen Charest, Los Angeles, CA (US)

(21) Appl. No.: 19/641,098

(22) Filed: Apr. 7, 2026

Related U.S. Application Data
(60) Provisional application No. 63/786,185, filed on Apr. 9, 2025.

(51) Int. Cl. G06Q 30/0251; G06N 20/00; G06Q 30/0241; H04L 9/00

(52) U.S. Cl. CPC G06Q 30/0255; G06N 20/00; G06Q 30/0277; H04L 9/008

(57) ABSTRACT

Disclosed are example embodiments of systems and methods for privacy-preserving advertisement targeting within a browser environment. The method includes collecting browsing activity data on a user device using a browser extension or browser and storing that data locally. A machine learning model is trained or updated within the extension using the local data to generate model parameters. A user profile embedding is derived based on the model using one or more model parameters. The embedding is sent to an advertisement server without transmitting raw browsing activity. The server performs a lookalike or nearest-neighbor comparison on the embedding to determine a relevant advertisement. The extension receives and presents the advertisement decision based on the lookalike matching, nearest neighbor comparison, or other algorithm while ensuring that the raw data remains private to the user device.

### CROSS-REFERENCE TO RELATED APPLICATION

This application claims priority to U.S. Provisional Patent Application No. 63/786,185, filed on Apr. 9, 2025, the disclosure of which is incorporated herein by reference in its entirety.

### TECHNICAL FIELD

The present disclosure relates generally to digital advertising systems, and more specifically, some embodiments relate to privacy-preserving on-device user profiling and targeted advertisement delivery.

### BACKGROUND

Online advertising has traditionally relied on centralized tracking techniques, such as cookies, tracking pixels, and third-party scripts, to gather extensive user behavioral data. These methods result in user data being transmitted to and stored on remote servers beyond the user's control. While effective for targeted advertising, this practice raises privacy concerns and exposes users to data misuse or unauthorized access risks.

In response to these challenges, regulations such as the General Data Protection Regulation (GDPR) and the California Consumer Privacy Act (CCPA) have emerged alongside technical efforts to limit the scope of data collection. Federated learning and on-device grouping methods attempt to mitigate data exposure, but they often suffer from limited modeling precision or residual risks of data leakage.

### SUMMARY

In an example implementation, a privacy-preserving browser extension or browser that operates locally on a user device to collect behavioral browsing data and derive a compact user profile embedding using on-device machine learning. The embedding may be encrypted and transmitted to a remote advertisement server, which selects relevant ads using lookalike matching without ever accessing the user's raw data or unencrypted profile. This approach preserves user privacy while supporting effective ad targeting.

One example embodiment includes a method for privacy-preserving advertisement targeting within a browser environment. The method includes collecting browsing activity data on a user device using a browser extension or browser and storing that data locally. A machine learning model is trained or updated within the extension using the local data to generate model parameters. A user profile embedding is derived based on the model using one or more model parameters. The embedding is sent to an advertisement server without transmitting any raw browsing activity. The server performs a lookalike or nearest-neighbor comparison, or other algorithm on the embedding to determine a relevant advertisement. The extension receives the advertisement decision based on the lookalike matching, nearest neighbor comparison, or other algorithm and presents it, while ensuring that the raw data remains private to the user device.

Another example embodiment includes a system for privacy-preserving advertisement targeting. The system includes a user device with a browser capable of executing content scripts and a background process of a browser extension or browser, a local storage component for browsing activity data and model parameters, and a machine learning module for generating a user profile embedding. The user device also includes an encryption module that encrypts the embedding before transmission. An advertisement server receives the encrypted embedding, performs a similarity or lookalike matching process using reference embeddings associated with campaigns, and transmits a selected advertisement or ad identifier to the user device. The system keeps browsing data private on the device and ensures that the advertisement server never obtains a decrypted version of the user profile.

A further example embodiment includes a non-transitory computer-readable storage medium with instructions that, when executed by a processor on a user device, cause the device to collect browsing activity through a browser extension or browser, train or update a local machine learning model to generate parameters defining a user profile embedding, and send the representation to an advertisement server. The device also receives a targeted advertisement based on lookalike matching or other algorithm by the server. Throughout the process, the raw browsing data and any unencrypted version of the profile embedding remain on the user device and are never sent to the server.

The features and advantages described in the specification are not all-inclusive. In particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the disclosed subject matter.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIG. 1 is a block diagram illustrating an example of an overall system architecture, including a browser extension on a user device communicating with an ad server.

FIG. 2 is a flowchart illustrating an example method for how the browser extension collects data, trains a local model, generates an embedding, and transmits the encrypted embedding to the server.

FIG. 3 is a block diagram of the server-side process for lookalike matching and advertisement delivery.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

The detailed description set forth below in connection with the appended drawings is intended as a description of configurations and is not intended to represent the only configurations in which the concepts described herein may be practiced. The detailed description includes specific details to provide a thorough understanding of various concepts. However, it will be apparent to those skilled in the art that these concepts may be practiced without these specific details. In some instances, well-known structures and components are shown in block diagram form in order to avoid obscuring such concepts.

The present disclosure relates to systems and methods for privacy-preserving advertisement targeting within a browser environment. In example embodiments, a browser extension or browser may operate entirely on a user device to collect browsing activity data, derive a user profile through local machine learning, and transmit an encrypted representation of that profile to a remote advertisement server. This architecture may support targeted advertising while maintaining strict limitations on what user data is shared externally. Notably, raw browsing activity data may remain entirely local to the user device.

Embodiments of the systems, methods, and devices described herein may have one or more of the following capabilities. For example, one embodiment of the systems, methods, and devices described herein may include a browser extension or browser that captures user browsing activity locally, derives a privacy-preserving user profile, encrypts the profile, and sends the encrypted result to a remote advertisement server to facilitate targeted ad delivery without exposing sensitive user data.

In one example implementation, an embodiment involves a browser extension or browser that collects browsing activity data on a user device, trains a machine learning model locally, and generates a user profile embedding that captures user interests. The profile embedding is encrypted before being transmitted to an advertisement server. The server performs lookalike modeling or similarity-based ad matching using the encrypted embedding, without accessing unencrypted user data, and returns relevant ads to the user device.

In example embodiments, the disclosed system may improve upon traditional digital advertising techniques by implementing a privacy-preserving architecture using specific technical components. The system operates entirely within the user's browser environment and leverages a browser extension or browser that locally collects browsing activity data, trains or updates a lightweight machine learning model, and generates a compact user profile embedding on the user device. Rather than transmitting raw data or even unencrypted representations, the system encrypts the embedding before any network transmission. This improves both data security and user privacy while enabling targeted advertising functionality. Furthermore, in some example embodiments, these systems and methods may improve the functioning of a computer itself by reducing network load, enhancing local performance, and preventing remote access to private data.

In some embodiments, the system is configured according to a strict architectural constraint in which raw browsing activity data is retained exclusively within the user device and is not transmitted to any remote system. The browser extension or browser enforces this constraint by performing all data collection, aggregation, and model training operations locally, and by restricting outbound communications to encrypted representations that do not permit reconstruction of the underlying browsing activity. This constraint is implemented as part of the system architecture rather than as a user-selectable preference, thereby preventing inadvertent or unauthorized disclosure of raw behavioral data.

The use of on-device machine learning, in combination with user-side encryption and server-side encrypted similarity matching, provides a specific and unconventional technical solution to the longstanding privacy risks associated with behavioral advertising. In contrast to conventional client-server tracking systems, which transmit large volumes of user data to centralized databases, this system minimizes data exposure and decentralizes computation.

In some embodiments, the use of partially homomorphic encryption or secure enclave-based decryption enables similarity matching on encrypted embeddings without revealing the user's identity or behavioral traits. This architecture departs from known approaches by providing real-time personalized ad delivery with no direct access to unencrypted user data.

In some embodiments, similarity matching operations performed by the advertisement server are executed on encrypted embeddings without requiring decryption of the embeddings into an unencrypted domain accessible to the server. For example, partially homomorphic encryption schemes or secure execution environments may be used to compute similarity scores or distance metrics directly on encrypted data. As a result, the server is capable of performing lookalike matching while remaining cryptographically incapable of accessing the underlying user profile representation, thereby enforcing privacy guarantees at a computational level rather than relying solely on policy-based controls.

Furthermore, the system includes interface-level controls enabling users to monitor or reset their profile, view inferred interests, and control whether encrypted embeddings are shared. These controls are implemented in a technical environment (browser extension architecture) and directly address user consent and transparency requirements under emerging privacy regulations. By integrating model training, profile management, and ad delivery entirely within the constrained execution environment of a browser extension or browser, the system demonstrates an improvement to the functioning of the computer system itself in the context of secure advertising delivery.

This system may provide improvement not only in the functionality of ad targeting, but also to the operation of the computing device itself. By offloading modeling and encryption to the browser extension or browser, the system reduces the need for external network communication, lowers server-side computational load, and improves local resource utilization. These technical benefits are achieved through a novel arrangement of browser-based components, data storage APIs, and encryption modules not previously combined in this manner for advertisement delivery.

In example embodiments, the described architecture reduces network bandwidth consumption relative to conventional advertising systems by eliminating transmission of raw browsing event streams and replacing such transmissions with compact, fixed-dimensional encrypted embeddings. Additionally, server-side computational load is reduced by shifting model training and feature extraction operations to the user device. This redistribution of computation improves scalability of the overall system and reduces latency associated with centralized processing of large-scale behavioral datasets. Furthermore, by minimizing remote storage of user-specific data, the system reduces the attack surface for data breaches and improves overall system security.

Disclosed are example embodiments of a method for providing privacy-preserving advertisement targeting within a browser environment. The method includes collecting browsing activity data via a browser extension or browser on a user device, training or updating a local machine learning model based on that data, deriving a user profile embedding from the model, and transmitting the encrypted version to an ad server. The server performs similarity matching to select an ad, and the extension receives and displays the ad locally, ensuring raw user data never leaves the device.

Disclosed are example embodiments of a system comprising a user device and advertisement server for implementing privacy-preserving advertisement targeting. The user device includes a browser extension or browser with content scripts and background processes for local data collection, a machine learning module for generating embeddings, and an encryption module for protecting those embeddings. The advertisement server performs lookalike matching using the encrypted embeddings and sends relevant advertisements back to the user device. The server does not access unencrypted user profile embeddings or raw browsing data.

The features and advantages described in the specification are not all-inclusive. In particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the disclosed subject matter.

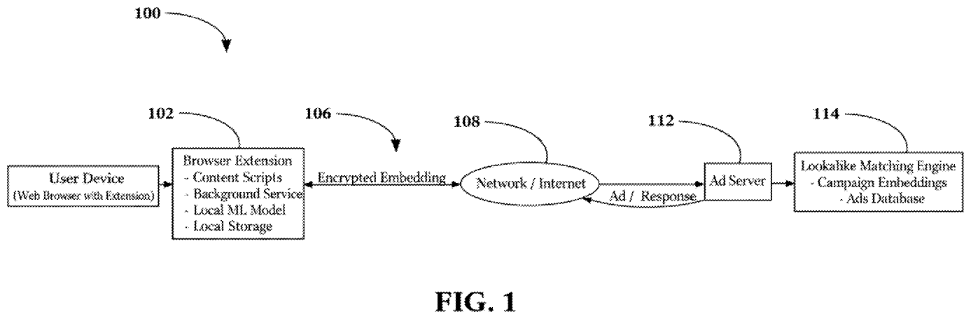

FIG. 1 is a block diagram 100 illustrating an example of an overall system architecture, including a browser extension 104 on a user device 102 communicating with an ad server 112. As illustrated, the user device 102 includes the browser extension 104, which may perform several functions. Browser extension 104 may capture browsing activity, manage a local machine learning model, and derive a user profile embedding based on that model. The embedding represents aggregated user interests in a compact vector form. This user profile embedding may be encrypted within the user device 102 before transmission 106. The encrypted embedding may be sent over a network 108 to an ad server 112. Ad server 112 may contain a lookalike matching engine 114 that may compare the received encrypted embedding with a collection of reference embeddings associated with different ad campaigns. Based on the similarity score or distance metric (e.g., in encrypted space), ad server 112 may select the most relevant advertisement and transmit it back (e.g., ad response 110) to the user device for display.

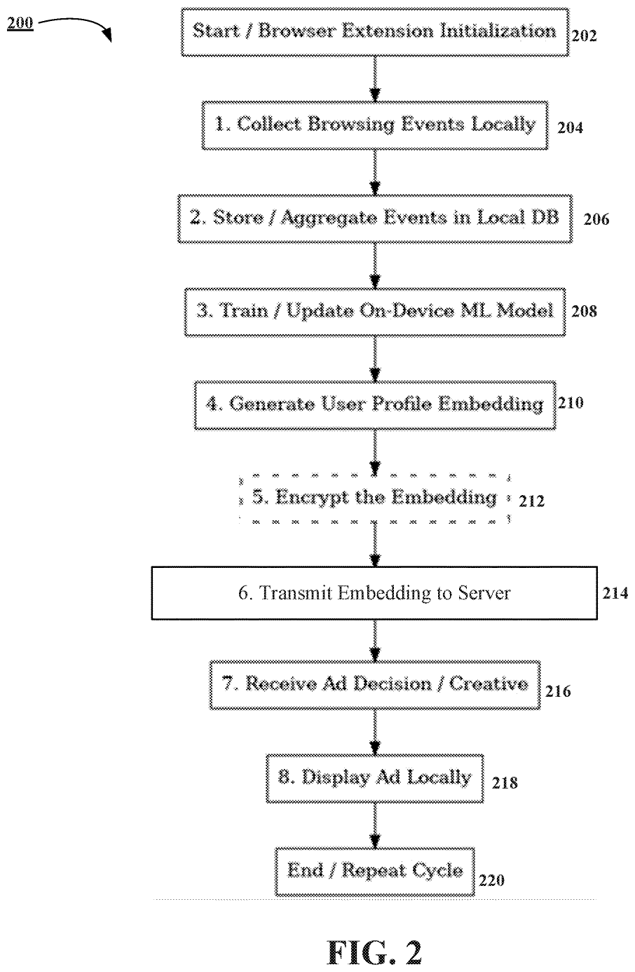

FIG. 2 is a flowchart illustrating an example method 200 of how the browser extension may collect data, train a local model, generate an embedding, and transmit the encrypted embedding to the server. After the start and/or initialization 202, the flow may begin with the extension monitoring user behavior, such as domain visits, time on page, scroll depth, and user clicks, and collecting the browsing events 204, e.g., locally at the user device 102, within the browser extension 104, FIG. 1. These events may be captured by content scripts and forwarded to the extension's background service. The background process may aggregate the signals and stores them in local storage (e.g., IndexedDB) 206. Periodically and/or after a threshold number of events, the browser extension (or browser) may train and/or update a machine learning model 208 —such as a small neural network implemented via TensorFlow.js—based on the stored activity. The trained model may generate and output user profile embedding 210, a fixed-dimensional feature vector that captures interest signals. This embedding may optionally be encrypted using a privacy-preserving method (e.g., partially homomorphic encryption or a secure symmetric cipher) 212 and transmitted to the ad server 214. For example, embedding may be transmitted to the ad server. In another example, encrypted embedding may be transmitted to the ad server. The extension awaits an ad response and, once received 216, injects or displays the selected ad within the user's browsing experience 218. The cycle may then end or repeat 220.

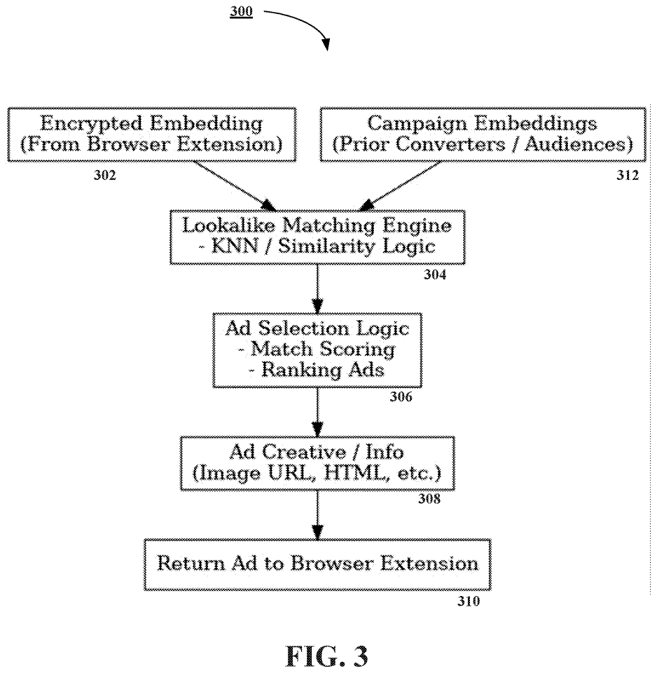

FIG. 3 is a block diagram 300 of the server-side process for lookalike matching and advertisement delivery. When the ad server receives the encrypted embedding from the browser extension 302, the ad server initiates a similarity computation (e.g., within the lookalike matching engine) 304 between the received embedding and a set of encrypted or partially encrypted campaign embeddings stored in the server database. These campaign embeddings may be derived from past user interactions or advertiser-defined target segments. The matching engine may apply a K-nearest neighbor (KNN) algorithm, clustering technique, or other similarity function within the encrypted domain (depending on the encryption scheme). Upon identifying a matching or nearest cluster, the ad server consults the ad selection logic to determine the most appropriate advertisement corresponding to that segment, which may include one or more of match scoring and ranking ads 306. The server may transmit either the creative ad asset (e.g., image, HTML, or script) or an identifier for ad rendering back to the user device 308, e.g., at the browser extension 310. In the example embodiment, the raw user profile embedding is never exposed to the server, ensuring that sensitive user data remains private. Campaign embeddings (prior converters/audiences) 312 may also be processed by the lookalike matching engine using, for example, KNN Similarity logic 304.

User interactions with the displayed advertisement—such as clicks or conversions—may be monitored locally by the extension. These interactions may be captured in a privacy-preserving manner and aggregated or encrypted prior to reporting. For instance, the extension may periodically submit anonymized engagement metrics indicating, for example, “5 conversions occurred within Cluster B” without revealing the individual actions of specific users. In example embodiments, the system may operate according to the following sequence: First, the user installs the browser extension or browser and grants consent for monitoring browsing activity. As the user navigates the web, content scripts may collect non-sensitive behavioral signals such as domain visits, scroll events, and time-on-page, forwarding these to a background script. The background component may aggregate and store the data locally. Periodically or upon reaching a defined event threshold, a lightweight machine learning model may be trained or updated to produce a user profile embedding. This embedding may then be encrypted using one of several available privacy-preserving strategies. The encrypted representation may be transmitted to the advertisement server, which performs a similarity or lookalike-matching operation against reference embeddings associated with campaigns. The extension may return and display a selected advertisement based on the match. Any subsequent ad interactions may be tracked locally and reported in aggregate form to ensure campaign performance monitoring without compromising user identity.

In some embodiments, the extension may also locally track user engagement with the delivered advertisements—such as clicks or conversions—on the user device. Only aggregated or anonymized signals may be sent back to the server for attribution and performance analysis, potentially helping ensure that the user's data remains on the local device and potentially helping ensure compliance with privacy regulations. The architecture outlined herein offers a balanced tradeoff between ad targeting precision and user privacy, relying on on-device learning, minimal data sharing, and encrypted inference mechanisms.

In example embodiments, browsing activity data may refer to structured observations about a user's interaction with web content. These data points may include, for instance, domain names visited, the amount of time a tab remains in focus, scrolling behavior, and interactions such as clicks. To ensure privacy, personally identifiable information or typed inputs may be excluded from the collected dataset. The browser extension (or browser) may inject one or more content scripts into visited pages to observe and report these signals. These scripts may be designed to operate efficiently, avoiding computational overhead and preserving a smooth user experience.

Captured event data may be routed to a background script or service worker associated with the extension. This component may manage a local data store—using, for example, IndexedDB or browser-provided storage APIs—to retain user interaction logs and model parameters. The data may be periodically transformed into aggregated features such as “number of visits to technology-related domains over the past week” or “average time spent on news articles.”

In some embodiments, the browser extension or browser may enforce restrictions on outbound data transmission using browser-level APIs and permission controls. For example, network request interception mechanisms may be used to block or filter attempts to transmit raw browsing activity data, ensuring that only encrypted embeddings or approved aggregated signals are communicated to external systems. The extension may operate within a sandboxed execution environment that isolates local data storage and machine learning operations from external scripts, thereby preventing unauthorized access or leakage of locally stored behavioral data.

In some embodiments, browsing activity data collected by the browser extension or browser is stored exclusively within local storage of the user device and is not transmitted to any remote system. The local storage mechanism may include browser-provided storage APIs, IndexedDB, or other on-device data repositories that are accessible only within the execution context of the browser extension or browser. The system may be configured such that all operations involving raw browsing activity data—including aggregation, feature extraction, and preparation of training inputs—are performed locally on the user device. In this manner, the architecture enforces a data-locality constraint in which raw browsing activity data remains confined to the user device throughout operation.

In example embodiments, the browser extension or browser executes a machine learning module configured to train or update a model using the locally stored browsing activity data and to derive a user profile embedding based on one or more model parameters generated by the model. The training or updating of the machine learning model and derivation of the user profile embedding are performed locally on the user device without reliance on remote computational resources. This local processing enables the system to generate a compact representation of user behavior while maintaining separation between raw data and any external systems.

In some embodiments, the user profile embedding generated by the browser extension or browser is encrypted on the user device prior to transmission to a remote advertisement server. The encryption process may utilize one or more cryptographic techniques, including symmetric encryption, public-key encryption, or partially homomorphic encryption, to produce an encrypted embedding suitable for transmission over a network. The encrypted embedding may be configured to preserve structural properties necessary for similarity-based comparison while preventing access to the underlying feature values.

In example embodiments, the advertisement server is configured to perform similarity-based matching operations on the encrypted embedding without decrypting the encrypted embedding into an unencrypted form accessible to the server. For example, the server may execute similarity computations using homomorphic operations, secure execution environments, or other privacy-preserving computation techniques that allow distance or similarity metrics to be evaluated on encrypted data. This enables the server to identify relevant advertisements without accessing or reconstructing the underlying user profile information.

In some embodiments, the encrypted embedding is configured such that the advertisement server is unable to reconstruct the underlying browsing activity data or individual behavioral events from the encrypted embedding. The embedding may represent aggregated or transformed features that do not preserve raw event-level granularity, and the encryption process further prevents inversion or recovery of the original data. As a result, the system maintains a separation between user-specific behavioral data retained on the user device and the data accessible to the advertisement server.

In some embodiments, a lightweight machine learning model may be trained or incrementally updated within the extension. The model may be implemented in JavaScript using frameworks such as TensorFlow.js. Examples of applicable model types may include feedforward neural networks, autoencoders, or classical models such as logistic regression or decision trees. These models may be trained using the locally stored data to produce a compressed user representation—a vector embedding—reflecting aggregated interests or behavioral patterns.

To ensure smooth user experience and minimal resource consumption, the extension may employ lightweight models and optimized scheduling strategies. For example, machine learning tasks such as training or inference may be offloaded to background threads using Web Workers, thereby preventing interface lag or page slowdown. The extension may rely on TensorFlow. js with WebGL acceleration to leverage GPU resources efficiently without overheating the device or depleting the battery. The size and complexity of the machine learning model may be selected to balance representational accuracy with responsiveness. In some embodiments, model updates may occur during periods of browser inactivity or after a defined quantity of new browsing events has been accumulated, further minimizing runtime disruption.

For devices with limited processing capabilities, a fallback mode may be supported wherein the extension uses a static, pre-trained model for embedding generation without on-device training. This mode may provide reduced personalization but preserve core privacy guarantees.

In some embodiments, the browser extension or browser may detect a low-resource condition on the user device—such as limited CPU availability, memory pressure, or low battery level—and respond by generating the user profile embedding using a static, pre-trained model rather than performing on-device training. The static model may be stored locally on the user device and used to produce a user profile embedding based on the available browsing data. This fallback approach may preserve core personalization functionality while avoiding resource-intensive computation under constrained device conditions.

The user profile embedding may be an N-dimensional feature vector, where N may be between 16 and 256 dimensions. This embedding may capture behavioral similarities between users while excluding granular event data. Inference may be executed periodically or triggered when a threshold quantity of new data is observed.

In some embodiments, the extension may assign a timestamp or version tag to each generated embedding. This may enable expiration logic, wherein outdated or stale embeddings are discarded or refreshed periodically to ensure that ad targeting reflects current user interests and reduces fingerprinting risk.

In some embodiments, if the user is offline or the ad server is temporarily unavailable, the browser extension or browser may queue the encrypted embedding and delay transmission until network connectivity is restored. The system may also cache recent advertisement responses for continuity of user experience.

In addition to simple feedforward neural networks, other model types may be used depending on system requirements and user behavior patterns. For example, an autoencoder may be trained to learn compressed latent representations of browsing interests, capturing a broader range of patterns in a compact form. A recurrent neural network (RNN) or long short-term memory (LSTM) network may be used in scenarios where temporal ordering of browsing data is significant. In some embodiments, the model may be incrementally updated after each event, while in others, batch training may be scheduled after reaching a threshold volume of activity. The training schedule may be dynamically adjusted based on system resource availability, user device performance, or inferred changes in behavior over time.

Before transmission, the embedding may be encrypted using one of several available encryption strategies. In example embodiments, a partially homomorphic encryption scheme such as Paillier, BFV, or CKKS may be applied to the embedding, allowing computations such as similarity scoring or nearest-neighbor matching to occur without decryption. Other implementations may employ symmetric encryption methods such as AES, or public-key approaches such as RSA, with the option of decryption occurring in a secure enclave on the server. As an alternative or complement to encryption, differential privacy techniques may be used, where random perturbations are introduced to the embedding prior to encryption to reduce the possibility of vector inversion or de-anonymization.

In example embodiments, the encryption of the user profile embedding is not merely for data protection during transmission, but enables specific computational functionality at the advertisement server. In particular, the encrypted embedding permits similarity-based matching operations to be performed without exposing the underlying feature values, thereby enabling privacy-preserving inference. This capability allows the system to achieve targeted advertisement selection while maintaining separation between user-specific behavioral data and server-side processing logic.

Various strategies may be employed to encrypt the user profile embedding before transmission. In some embodiments, partially homomorphic encryption schemes—such as Paillier, BFV, or CKKS—may be used to permit the advertisement server to perform similarity calculations without accessing the unencrypted embedding. In other example embodiments, the extension may apply symmetric encryption (e.g., AES) or public-key encryption (e.g., RSA), with decryption occurring only within a trusted execution environment on the server. Other alternatives may include secure two-party computation (2PC) protocols or private information retrieval (PIR), which may allow the server to compare embeddings or retrieve matching ads without ever learning the user's identity or raw vector. Each encryption approach may introduce tradeoffs between computational efficiency, implementation complexity, and the degree of privacy preservation, and the architecture may be adapted to meet resource constraints on the user device or latency requirements for ad serving.

The encrypted embedding may then be transmitted to an advertisement server, which may maintain a library of reference embeddings corresponding to prior converters or user segments. Each reference embedding may be stored in encrypted or otherwise privacy-protecting form. In some example embodiments, the server may execute a lookalike matching algorithm, such as approximate nearest-neighbor search, using either homomorphic operations or secure computation protocols to determine the closest reference cluster to the incoming user profile.

Once a suitable match is identified, the advertisement server may return a selected advertisement or metadata identifying the ad. This response may include a URL to a static image, a payload referencing a video or interactive creative, or simply an identifier mapping to a known ad stored within the extension. The extension may then render the advertisement within the user's browsing environment—such as within a sidebar, a custom pop-up, or injected in a predefined location on the page.

In example embodiments, measures may be implemented to reduce the risk of adversarial manipulation by users attempting to alter or spoof the embedding to obtain different advertisements. For instance, the extension may perform integrity checks on stored model parameters or apply obfuscation techniques to hinder reverse engineering. The advertisement server may employ heuristics or statistical consistency checks to detect embeddings that deviate significantly from expected distributions. In some embodiments, the system may include a partial validation step, where embeddings are cross-checked against typical behavior clusters or pass through a lightweight anomaly detector. Although complete client-side protection may be difficult to guarantee, these approaches may help deter common manipulation tactics and maintain trust in the ad targeting system.

In some embodiments, a user interface may be presented to allow user control over the system's behavior. The interface may include the ability to view inferred interest categories, reset or delete stored browsing data, toggle the transmission of encrypted embeddings, or disable specific categories of advertisements. These options may support regulatory compliance with data protection laws and may enhance user trust in the system's operation.

In example embodiments, the browser extension or browser may include a user interface component configured to provide transparency and control over local data collection and ad personalization. This user interface may be presented via a popup window or a dedicated settings page accessible from the browser's toolbar. Users may be able to view a list or visualization of inferred interest categories based on the current model output. Additionally, users may be provided with options to reset or delete local model parameters, clear stored browsing activity data, disable transmission of the encrypted user profile embedding to the advertisement server, or opt out of specific categories of advertisements. These controls may be designed to enhance user trust and to support compliance with data protection regulations by offering meaningful consent and configurability.

In some embodiments, the user interface is operatively coupled to the underlying data processing and transmission components of the system to provide direct control over system behavior. For example, user interaction with the interface may trigger deletion of locally stored model parameters, regeneration of the user profile embedding, or disabling of outbound transmission of encrypted embeddings by modifying execution paths within the browser extension. In this manner, the user interface provides functional control over system operations rather than merely presenting information, thereby enabling dynamic reconfiguration of privacy and personalization parameters at runtime.

Although emerging initiatives such as Brave Ads, Google Topics, and FLEDGE represent steps toward user-centric advertising models, such systems still rely on either centralized components or relatively coarse-grained interest grouping. In contrast, the described architecture may offer finer modeling granularity by performing on-device machine learning and encrypted similarity computation with minimal or no exposure of raw user data. Moreover, this system may provide users with greater visibility into their inferred preferences and more control over their participation in the advertising ecosystem. No public system currently implements this combination of local profiling, encrypted ad matching, and real-time user control as described herein.

The described architecture may enable advertisers to serve relevant ads to users without collecting or storing raw personal data. By offloading data collection, modeling, and encryption to the user device, the system may substantially reduce the privacy risks associated with traditional adtech systems. Moreover, the use of modern browser extension technologies and JavaScript-based ML frameworks may support broad compatibility with common browsers, including Chrome, Firefox, and Edge.

The described approach may also support incremental development. For instance, early prototypes may use simpler encryption strategies or even hashed representations of embeddings, with the potential to migrate to more sophisticated schemes such as homomorphic encryption as computational resources permit. Similarly, the machine learning model may begin with a static pre-trained embedding generator and evolve toward an adaptive, continuously updating system.

Example embodiments may be particularly useful in environments where user trust and regulatory compliance are paramount. The system may be deployed in consumer browsers, enterprise endpoints, or specialty contexts such as educational platforms or healthcare portals—anywhere privacy-preserving personalization may be desirable.

In some embodiments, the described system enforces privacy preservation and data locality as a technical constraint of the execution architecture rather than as a configurable policy or preference. In particular, the browser extension or browser is structured such that raw browsing activity data is retained exclusively within the execution context of the user device and is not accessible to, or transmissible to, any remote system. Outbound communications from the user device are programmatically constrained to encrypted user profile embeddings or aggregated signals that do not permit reconstruction of underlying browsing activity. As a result, the advertisement server is technically incapable of obtaining raw behavioral data or unencrypted profile representations, regardless of server configuration or advertiser behavior.

The system further departs from conventional client-server advertising architectures by deliberately redistributing computational responsibilities between the user device and the advertisement server. Feature extraction, model training or updating, and embedding generation are performed locally within the browser environment, while the remote server is limited to similarity-based selection operations on received representations. This redistribution reduces centralized data aggregation, alters network communication patterns, and constrains server-side computation to a narrowly defined matching function. In doing so, the system exhibits different scaling, security, and fault-isolation characteristics than traditional advertising pipelines, thereby improving the operation of the computing system as a whole.

The technical contribution of the disclosed system does not reside in the particular mathematical form of the machine learning model, the dimensionality of the embedding, or the specific similarity metric employed. Rather, the improvement arises from the manner in which data processing is partitioned, transformed, and restricted across computing components, and from the use of encrypted representations to enable remote computation without exposure of sensitive inputs. The disclosed architecture enables functionality that cannot be achieved through conventional statistical analysis or mental processes, as the operations involve coordinated execution across isolated client-side storage, encrypted transformation, and constrained server-side computation within a live browser environment.

It should be appreciated that while several technical components are described—such as content scripts, local storage, machine learning modules, encryption systems, and server-side matching logic—each may be implemented in various forms. The system may use different combinations of JavaScript libraries, data formats, and transport protocols. Furthermore, example embeddings may be generated using distinct learning paradigms, including supervised, unsupervised, or self-supervised learning, depending on the available data and design constraints.

This architecture may represent a meaningful departure from centralized tracking and personalization methods. By decentralizing both data handling and personalization logic, the disclosed system may provide a user-centric alternative that remains technically effective for advertisers while protecting the privacy and autonomy of users.

One or more elements or aspects or steps, or any portion(s) thereof, from one or more of any of the systems and methods described herein may be combined with one or more elements or aspects or steps, or any portion(s) thereof, from one or more of any of the other systems and methods described herein and combinations thereof, to form one or more additional implementations and/or claims of the present disclosure.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the methods used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared or otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following disclosure, it is appreciated that throughout the disclosure terms such as “processing,” “computing,” “calculating,” “determining,” “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. It will be appreciated that a variety of programming languages may be used to implement the teachings of the invention as described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method for providing privacy-preserving advertisement targeting within a browser environment, the method comprising:
collecting, by a browser extension or a browser executing on a user device, browsing activity data indicative of user interactions, wherein the browsing activity data is stored locally on the user device;
training or updating a machine learning model, within the browser extension or browser, using at least a portion of the browsing activity data to generate one or more model parameters;
deriving, based on the machine learning model, a user profile embedding using one or more model parameters;
transmitting, from the browser extension or browser to an advertisement server, the embedding while withholding raw browsing activity data from the advertisement server;
performing, by the advertisement server, a lookalike matching, nearest neighbor comparison, other algorithm, or similarity computation on the embedding to determine a relevant advertisement;
receiving, by the browser extension or browser, an advertisement decision from the advertisement server based on the lookalike matching, nearest neighbor comparison, other algorithm, or similarity computation; and
presenting the relevant advertisement to the user device, wherein the raw browsing activity data remains private to the user device.

2. The method of claim 1, further comprising encrypting the user profile embedding on the user device to produce an encrypted embedding, and wherein encrypting the user profile embedding further comprises applying a partially homomorphic encryption scheme that enables the advertisement server to perform distance or similarity calculations on the encrypted embedding without decrypting it.

3. The method of claim 1, wherein the machine learning model is a neural network implemented via a JavaScript-based framework, and wherein deriving the user profile embedding comprises generating a feature vector of dimensionality between 16 and 256.

4. The method of claim 1, further comprising injecting a content script into one or more web pages to capture at least one of: (i) domain information, (ii) page view duration, (iii) user scroll depth, or (iv) user clicks on page elements, wherein the content script sends captured information to a background process of the browser extension or browser.

5. The method of claim 1, further comprising updating the user profile embedding periodically or upon detecting a threshold quantity of new browsing activity data, so that the user profile embedding reflects changes in user interests over time.

6. The method of claim 1, further comprising:
tracking, within the browser extension or browser, user engagement with the presented advertisement; and
reporting, to the advertisement server, aggregated or encrypted indicators of advertisement performance, thereby permitting campaign attribution without revealing individual user activity logs.

7. The method of claim 2, wherein the partially homomorphic encryption scheme is selected from the group consisting of Paillier, BFV, and CKKS, enabling approximate distance computations between encrypted embeddings and reference embeddings maintained by the advertisement server.

8. The method of claim 1, further comprising injecting noise or perturbations into the user profile embedding prior to encrypting, to ensure that the embedding cannot be reverse-engineered to reveal specific user behavior.

9. The method of claim 1, wherein:
the browsing activity data is stored exclusively within local storage of the user device and is not transmitted to any remote system, and
the training or updating of the machine learning model and derivation of the user profile embedding are performed locally on the user device using the browsing activity data.

10. The method of claim 1, further comprising:
encrypting, by the browser extension or browser, the user profile embedding to generate an encrypted embedding prior to transmission to the advertisement server,
wherein the advertisement server performs the similarity-based matching operation on the encrypted embedding without decrypting the encrypted embedding, and
wherein the encrypted embedding is configured such that the advertisement server is unable to reconstruct the browsing activity data from the encrypted embedding.

11. A system for privacy-preserving advertisement targeting, comprising:
a user device comprising:
a browser configured to execute one or more content scripts and a background process of a browser extension or browser,
a local storage mechanism for retaining browsing activity data and machine learning model parameters, and
a machine learning module configured to generate a user profile embedding from the browsing activity data; and
an advertisement server configured to:
receive an encrypted user profile embedding from the browser extension or browser,
perform a lookalike matching process nearest neighbor comparison, other algorithm or similarity computation on the encrypted user profile embedding relative to reference embeddings associated with one or more advertising campaigns, and
transmit a selected advertisement or advertisement identifier to the user device, wherein the browsing activity data remains private on the user device, and the advertisement server does not obtain a decrypted user profile embedding.

12. The system of claim 11, further comprising encrypting the user profile embedding on the user device to produce an encrypted embedding prior to network transmission; wherein the machine learning module comprises a TensorFlow. js component that operates within the background process of the browser extension or the browser, and wherein the system further includes a scheduling module that triggers incremental model training.

13. The system of claim 11, wherein the advertisement server is configured to store reference embeddings for each advertising campaign, each reference embedding derived from browsing or conversion data of previously engaged users, the reference embeddings also stored in an encrypted format.

14. The system of claim 11, wherein the user device further includes a user interface allowing a user to view or reset a local model's parameters or to disable the encryption and transmission of the user profile embedding.

15. The system of claim 11, wherein the advertisement server is configured to aggregate click or conversion data received in an encrypted or anonymized format from a plurality of user devices, thereby generating performance metrics for each advertisement campaign without exposing detailed user-level data.

16. The system of claim 11, wherein:
the local storage mechanism is configured to store the browsing activity data exclusively within the user device and to prevent transmission of the browsing activity data to the advertisement server, and
the machine learning module is configured to perform the training or updating of the machine learning model and derivation of the user profile embedding locally on the user device using the browsing activity data.

17. The system of claim 11, wherein:
the user device is configured to encrypt the user profile embedding to generate an encrypted embedding prior to transmission to the advertisement server, and the advertisement server is configured to perform the similarity computation on the encrypted embedding without decrypting the encrypted embedding,
wherein the encrypted embedding is configured such that the advertisement server is unable to reconstruct the browsing activity data from the encrypted embedding.

18. A non-transitory computer-readable storage medium storing program instructions that, when executed by one or more processors of a user device, cause the user device to:
capture browsing activity data within a browser extension or browser;
train or update a machine learning model using the browsing activity data to generate model parameters that define a user profile embedding;
send the representation to an advertisement server for lookalike matching, or other algorithm; and
receive from the advertisement server a targeted advertisement based on the lookalike matching, nearest neighbor comparison, or other algorithm,
wherein the program instructions are configured such that raw browsing activity data or a decrypted profile embedding is not transmitted to the advertisement server.

19. The non-transitory computer-readable storage medium of claim 18, wherein the program instructions further cause the user device to implement a partially homomorphic encryption scheme that allows the advertisement server to compute similarity or distance metrics on the encrypted representation without requiring decryption.

20. The non-transitory computer-readable storage medium of claim 18, wherein the program instructions are further configured to track any advertisement interactions locally and report an encrypted or aggregated summary of advertisement performance events to the advertisement server.
